(19) United States
(12) Patent Application Publication
(10) Pub. No.: US 2026/0102700 A1
(43) Pub. Date: Apr. 16, 2026

(54) ELECTRONIC DEVICE AND METHOD FOR REDUCING SERVER COST DURING MEDIA STREAMING

(71) Applicant: SAMSUNG ELECTRONICS CO., LTD., Suwon-si (KR)

(72) Inventors: Yeonwoo KIM, Suwon-si (KR); Sehyun KIM, Suwon-si (KR); Donguk KIM, Suwon-si (KR); Jongin LEE, Suwon-si (KR); Donghwa JEONG, Suwon-si (KR)

(73) Assignee: SAMSUNG ELECTRONICS CO., LTD., Suwon-si (KR)

(21) Appl. No.: 19/409,254

(22) Filed: Dec. 4, 2025

Related U.S. Application Data
(63) Continuation of application No. PCT/KR2024/095774, filed on May 16, 2024.

(30) Foreign Application Priority Data
Jul. 6, 2023 (KR) 10-2023-0087888

(51) Int. Cl. A63F 13/52

(52) U.S. Cl. CPC A63F 13/52

(57) ABSTRACT

An electronic device includes a communication interface; and one or more processors operatively connected to the communication interface, wherein the one or more processors are configured to: execute an application at a first performance level by running a first instance, control the communication interface to stream a screen corresponding to the execution of the application to an external device, and execute, based on information corresponding to a user absence received from the external device through the communication interface, the application at a second performance level by running a second instance, wherein the second performance level is lower than the first performance level.

### CROSS-REFERENCE TO RELATED APPLICATIONS

This application is a Bypass Continuation Application of International Application PCT/KR2024/095774 filed on May 16, 2024, which claims priority to Korean Application No. 10-2023-0087888, filed on Jul. 6, 2023, in the Korean Intellectual Property Office, the disclosures of which are incorporated by reference herein in their entireties.

### BACKGROUND

### 1. Field

The present disclosure relates to an electronic device and method for media streaming, and more particularly, to an electronic device and method for reducing server cost during media streaming.

### 2. Description of Related Art

With advancements of electronic technology, electronic devices offering various functions have been developed. In particular, systems enabling streaming remote play of video games using cloud computing technology have recently been developed.

For example, as illustrated in FIG. 1A, a cloud server may render a game, capture video, encode the captured video, and provide the encoded video to a display device (client), such as a television (TV), via real time streaming protocol (RTSP). The display device may decode and reproduce the encoded video, and upon receiving user input, the display device may transmit the user input to the cloud server, which may then render the game based by reflecting the user input. This process, however, incurs costs for the cloud server, and there is a problem in that the costs persist even when the user is away from his/her seat.

Furthermore, as illustrated in FIG. 1B, the cloud server may require a server instance for each user. The instance may be a virtual machine running in a cloud environment. For example, the server instance may run a game on the cloud server, and a thin client on a display device may transmit user input to a corresponding server instance, receive video from the server instance, and display the same. Such a server instance may be created only when a user runs a game.

That is, server costs may be incurred for a plurality of users, and unnecessary costs increase as users are more frequently away from their seats. In particular, high-performance server instances have higher hourly costs compared to low-performance server instances.

To address this issue, if a user is away from his/her seat for a certain period of time, it may be identified whether the user is still playing the game, and then, if there is no response from the user for a certain period of time, the server instance may be terminated. However, in this case, the game playing may be terminated regardless of the user's intent.

Therefore, a method for resolving the above problem is needed.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

According to an aspect of the disclosure, there is provided an electronic device including: a communication interface; and one or more processors operatively connected to the communication interface, wherein the one or more processors are configured to: execute an application at a first performance level by running a first instance, control the communication interface to stream a screen corresponding to the execution of the application to an external device, and execute, based on information corresponding to a user absence received from the external device through the communication interface, the application at a second performance level by running a second instance, wherein the second performance level is lower than the first performance level.

The one or more processors may be further configured to, based on a first period of time having elapsed since the information corresponding to the user absence was received, execute the application at the second performance level by running the second instance.

The one or more processors may include: at least one first processor; and at least one second processor having a lower performance than the at least one first processor, wherein the at least one first processor is configured to: execute the application at the first performance level by running the first instance, control the communication interface to stream the screen corresponding to the execution of the application to the external device, and based on the first period of time having elapsed since the information corresponding to the user absence was received, lower at least one of a transmission bit rate of the screen corresponding to the execution of the application or a resolution of the application by running the second instance.

The at least one first processor may be further configured to, based on a second period of time having elapsed since the information corresponding to the user absence was received, provide first information for controlling the at least one second processor to execute the application to the at least one second processor, the second period of time being greater than the first period of time, and the at least one second processor may be further configured to execute the application at a third performance level by running a third instance and control the communication interface to stream the screen corresponding to the execution of the application to the external device, the third performance level being lower than the second performance level.

The at least one second processor may be further configured to, based on a third period of time having elapsed since the information corresponding to the user absence was received, execute the application by running a fourth instance and terminate the streaming of the screen corresponding to the execution of the application, the third period of time being greater than the second period of time.

The at least one second processor may be further configured to: execute, based on information corresponding to a user presence received from the external device through the communication interface, the application at the third performance level by running the third instance and control the communication interface to stream the screen corresponding to the execution of the application to the external device, and provide second information for controlling the at least one first processor to execute the application to the at least one first processor, and the at least one first processor may be further configured to execute the application at the first performance level by running the first instance and control the communication interface to stream the screen corresponding to the execution of the application to the external device.

The first information includes an execution command of the at least one second processor and status information of the application, and the at least one first processor may be further configured to terminate the running of the second instance after providing the first information to the at least one second processor.

The one or more processors may be further configured to execute, based on information corresponding to a user presence received from the external device through the communication interface, the application at the first performance level by running the first instance.

The one or more processors may be further configured to execute, based on information on a waiting time of the application received from the external device, the application at the second performance level by running the second instance during the waiting time.

The one or more processors may be configured to execute, based on an execution command of the application received from the external device, the application at the first performance level by running the first instance.

According to an aspect of the disclosure, there is provided a control method of an electronic device, including: executing an application at a first performance level by running a first instance; streaming a screen corresponding to the execution of the application to an external device; and executing, based on information corresponding to a user absence received from the external device, the application at a second performance level by running a second instance, wherein the second performance level is lower than the first performance level.

The executing the application at the second performance level may include, based on a first period of time having elapsed since the information corresponding to the user absence was received, executing the application at the second performance level by running the second instance.

The executing the application at the first performance level may include executing the application at the first performance level by running, by at least one first processor, the first instance, the executing the application at the second performance level may include, based on the first period of time having elapsed since the information corresponding to the user absence was received, lowering at least one of a transmission bit rate of the screen corresponding to the execution of the application or a resolution of the application by running, by at least one second processor, the second instance, and the at least one second processor may have a lower performance than the at least one first processor.

The control method may further include: based on a second period of time having elapsed since the information corresponding to the user absence was received, providing, by the at least one first processor, first information for controlling the at least one second processor to execute the application to the at least one second processor, the second period of time being greater than the first period of time; and executing, by the at least one second processor, the application at a third performance level by running a third instance, the third performance level being lower than the second performance level.

The control method may further include: based on a third period of time having elapsed since the information corresponding to the user absence was received, executing the application by running a fourth instance by the at least one second processor, the third period of time being greater than the second period of time; and terminating the streaming of the screen corresponding to the execution of the application.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B are diagrams illustrating a server instance;

FIG. 2 is a block diagram illustrating a configuration of an electronic device according to an embodiment of the disclosure;

FIG. 3 is a block diagram illustrating a configuration of an external device according to an embodiment of the disclosure;

FIG. 4 is a block diagram illustrating a detailed configuration of an external device according to an embodiment of the disclosure;

FIGS. 5 and 6 are diagrams illustrating performance-based costs according to an embodiment of the disclosure;

FIG. 7 is a sequence diagram illustrating an operation based on a waiting time setting according to an embodiment of the disclosure;

FIG. 8 is a sequence diagram illustrating an instance change operation according to an embodiment of the disclosure;

FIGS. 9 and 10 are diagrams illustrating a timer function according to an embodiment of the disclosure; and

FIG. 11 is a flowchart illustrating a control method of an electronic device according to an embodiment of the disclosure.

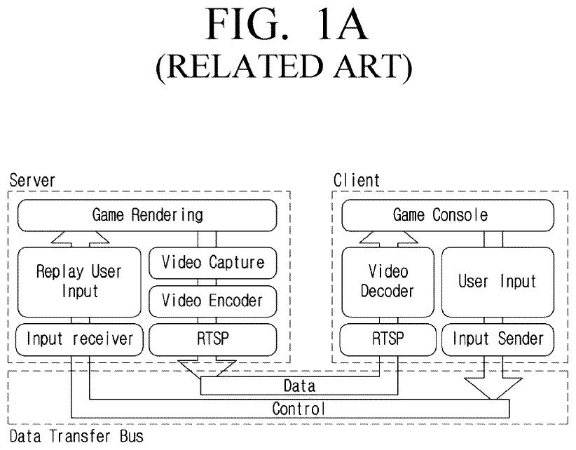

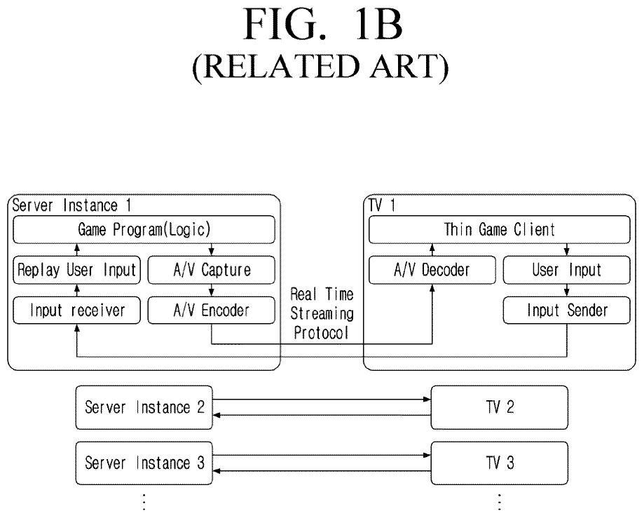

### DETAILED DESCRIPTION

An object of the disclosure is to provide an electronic device and a control method for reducing costs for a server instance based on a user who is away from his/her seat.

Hereinafter, the disclosure will be described in detail with reference to the accompanying drawings. As the present disclosure allows for various changes and numerous embodiments, embodiments will be illustrated in the drawings and described in detail in the detailed description. However, this is not intended to limit the present disclosure to particular modes of practice, and it will be appreciated that all changes, equivalents, and substitutes that do not depart from the spirit and technical scope of the disclosure are encompassed in the disclosure.

The terms used in the embodiments of the disclosure are general terms which are widely used now and selected considering the functions of the disclosure. However, the terms may vary depending on the intention of a person skilled in the art, a precedent, or the advent of new technology. In addition, in a specified case, the term may be arbitrarily selected. In this case, the meaning of the term will be explained in the corresponding description. Therefore, terms used in the disclosure may be defined based on a meaning of the terms and contents described in the disclosure, not simply based on names of the terms.

As used herein, the expression “have”, “may have”, “include”, or “may include” refers to the existence of a corresponding feature (e.g., numeral, function, operation, or constituent element, such as component), and does not exclude one or more additional features.

The expression of “at least one of A or B” is to be understood as indicating any one of “A” or “B” or “A and B”.

The expression “a first”, “a second”, “the first”, or “the second” used in various embodiments of the disclosure may modify various components regardless of their order and/or the importance but does not limit the corresponding components.

A singular expression includes a plural expression as long as they are clearly distinguished in the context. In the application, it should be understood that the terms, such as “comprising”, “including” are intended to express that features, numbers, steps, operations, constituent elements, part, or combinations thereof described in the specification are present and do not exclude existence or additions of one or more other features, numbers, steps, operations, constituent elements, part, or combinations thereof.

In this disclosure, the term “user” may indicate a person who uses an electronic device or a device (e.g., an artificial intelligence electronic device) that uses an electronic device.

Various embodiments of the disclosure will be described in detail with reference to the accompanying drawings.

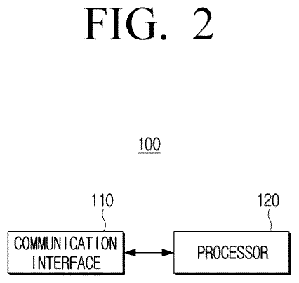

FIG. 2 is a block diagram illustrating a configuration of an electronic device 100 according to an embodiment of the disclosure.

The electronic device 100 is a device may be embodied as a server and is configured to create instances. For example, when a game execution command is received from an external device 200, the electronic device 100 may run an instance to render a game, capture a video, encode the captured video, and transmit the encoded video to the external device 200 via a real time streaming protocol (RTSP).

However, the electronic device 100 is not limited thereto, and any device capable of creating instances may be used.

According to FIG. 2, the electronic device 100 includes a communication interface 110 and one or more processors 120.

The communication interface 110 is a component that communicates with various types of external devices according to various communication methods. For example, the electronic device 100 may communicate with the external device 200, a user terminal, etc., through the communication interface 110.

The communication interface 110 may include a Wi-Fi module, a Bluetooth module, an infrared communication module, and a wireless communication module. Each communication module may be implemented in the form of at least one hardware chip.

The Wi-Fi module and the Bluetooth module perform communication using the Wi-Fi and Bluetooth protocols, respectively. In the case of using the Wi-Fi or Bluetooth module, various connection information, such as an service set identifier (SSID) and session key, is first transmitted and received, communication is connected using various connection information, and then, various information may be transmitted and received. The infrared communication module performs communication according to infrared data association (IrDA) technology, which transmits data wirelessly within a short distance using infrared rays existing in a wavelength between visible light and millimeter waves.

In addition to the communication methods described above, the wireless communication module may include at least one communication chip that performs communication according to various wireless communication standards, such as Zigbee, 3G (3rd Generation), 3GPP (3rd Generation Partnership Project), LTE (Long Term Evolution), LTE-A (LTE Advanced), 4G (4th Generation), and 5G (5th Generation).

Alternatively, the communication interface 110 may include a wired communication interface, such as high-definition multimedia interface (HDMI), (DisplayPort) DP, Thunderbolt, universal serial bus (USB), red, green, and blue (RGB), D-subminiature (D-SUB), or digital visual interface (DVI).

Furthermore, the communication interface 110 may include at least one of a local area network (LAN) module, an Ethernet module, or a wired communication module that performs communication using a paired cable, coaxial cable, or fiber optic cable.

The one or more processors 120 are configured to control the overall operation of the electronic device 100. Specifically, the one or more processors 120 may be connected to each component of the electronic device 100 and may control the overall operation of the electronic device 100. For example, the one or more processors 120 may be connected to components, such as the communication interface 110, memory, etc. and may control the operation of the electronic device 100.

The one or more processors 120 may include one or more of a CPU (central processing unit), a graphics processing unit (GPU), an accelerated processing unit (APU), a many integrated core (MIC), a neural processing unit (NPU), a hardware accelerator, or a machine learning accelerator. The one or more processors 120 may control one of other components of the electronic device 100 or any combinations thereof and perform operations related to communication or data processing. The one or more processors 120 may execute one or more programs or instructions stored in memory. For example, the one or more processors 120 may execute one or more instructions stored in the memory to perform a method according to an embodiment of the disclosure.

If the method according to an embodiment of the disclosure includes a plurality of operations, the plurality of operations may be performed by a single processor or by a plurality of processors. For example, when a first operation, a second operation, and a third operation are performed by the method according to an embodiment, the first, second, and third operations may all be performed by a first processor, the first and second operations may be performed by the first processor (e.g., a general-purpose processor), and the third operation may be performed by a second processor (e.g., an artificial intelligence-specific processor).

The one or more processors 120 may be implemented as a single-core processor including one core or as one or more multi-core processors including a plurality of cores (e.g., homogeneous multi-cores or heterogeneous multi-cores). Based on the one or more processors 120 being implemented as multi-core processors, each of the plurality of cores included in the multi-core processor may include internal processor memory, such as cache memory or on-chip memory, and a common cache shared by the plurality of cores may be included in the multi-core processor. In addition, each of the plurality of cores (or some of the cores) included in a multi-core processor may independently read and execute program instructions for implementing the method according to an embodiment of the disclosure, or all (or some) of the plurality of cores may be linked to read and execute program instructions for implementing the method according to an embodiment of the disclosure.

Based on the method according to an embodiment of the disclosure including a plurality of operations, the plurality of operations may be performed by one of the plurality of cores included in the multi-core processor, or by the plurality of cores. For example, when a first operation, a second operation, and a third operation are performed by the method according to an embodiment, the first, second, and third operations may all be performed by a first core included in the multi-core processor, or the first and second operations may be performed by the first core included in the multi-core processor and the third operation may be performed by the second core included in the multi-core processor.

In embodiments of the disclosure, the one or more processors 120 may refer to a system-on-chip (SoC) in which one or more processors and other electronic components are integrated, a single-core processor, a multi-core processor, or a core included in a single-core processor or multi-core processor, and here, the core may be implemented as a CPU, GPU, APU, MIC, NPU, hardware accelerator, or machine learning accelerator, but the embodiments of the disclosure are not limited thereto. However, for convenience of description, the operation of the electronic device 100 will be described hereinafter by the expression of the one or more processors 120.

The one or more processors 120 may run a first instance to execute an application at a first performance level. For example, upon receiving an execution command of an application from the external device 200, the one or more processors 120 may run a first instance to execute the application at the first performance level. Here, the application may be a game. However, the disclosure is not limited thereto, and the application may be any application related to a cloud service.

The one or more processors 120 may control the communication interface 110 to stream a screen corresponding to application execution to the external device 200. For example, the one or more processors 120 may control the communication interface 110 to encode a screen corresponding to application execution and stream the encoded screen to the external device 200. Alternatively, the one or more processors 120 may control the communication interface 110 to downscale the screen corresponding to application execution using a neural network model, encode the downscaled screen, and stream the encoded screen to the external device 200.

Based on information corresponding to user absence received from the external device 200 via the communication interface 110, the one or more processors 120 may run a second instance to execute the application at a second performance level which is a performance level lower than the first performance level of the first instance. For example, based on information indicating that the user of the external device 200 is absent received from the external device 200, the one or more processors 120 may run the second instance to execute the application at the second performance level which is a performance level lower than the first performance level of the first instance.

Based on a first period of time having elapsed since the information corresponding to the user's absence was received, the one or more processors 120 may run the second instance and execute the application at the second performance level. For example, based on one minute having elapsed since the information corresponding to the user's absence was received, the one or more processors 120 may run the second instance and execute the application at the second performance level. However, based on information corresponding to the user's presence received from the external device 200 or a user command for the application received within the first period of time after the information corresponding to the user's absence was received, the one or more processors 120 may maintain the first instance without running the second instance.

Based on the information corresponding to the user's presence received from the external device 200 via the communication interface 110, the one or more processors 120 may run the first instance and execute the application at the first performance level. For example, based on information corresponding to the user's presence received from the external device 200 via the communication interface 110, while the one or more processors 120 is running the second instance and executing the application at the second performance level, the one or more processors 120 may run the first instance and execute the application at the first performance level. However, without being limited thereto, based on a user command for the application received from the external device 200 via the communication interface 110, while the one or more processors 120 is running the second instance and executing the application at the second performance level, the one or more processors 120 may run the first instance and execute the application at the first performance level.

Based on information regarding a waiting time of the application received from the external device 200, the one or more processors 120 may run the second instance and execute the application at the second performance level during the waiting time. For example, the external device 200 may provide a timer function to receive information on the waiting time indicating the user's absence time from the user and transmit the received information to the electronic device 100. Based on the received waiting time information, the one or more processors 120 may run the second instance during the waiting time to execute the application at the second performance level.

The one or more processors 120 may include at least one first processor and at least one second processor with lower performance than the at least one first processor. The at least one first processor may be embodied as a first subprocessor and the at least one second processor may be embodied as a second subprocessor.

The at least one first processor may run the first instance to execute the application at the first performance level and control the communication interface 110 to stream a screen corresponding to the application execution to the external device 200. Based on the first period of time having elapsed since the information corresponding to the user's absence was received, the one or more processors 120 may run the second instance to lower at least one of a transmission bit rate of the screen corresponding to the application execution or the resolution of the application. Costs may be saved as the at least one first processor lowers the running performance of the application.

Based on a second period of time, greater than the first period of time, having elapsed since the information corresponding to the user's absence was received, the at least one first processor may provide first information for controlling the at least one second processor to execute the application to the at least one second processor, and the at least one second processor may control the communication interface 110 to run a third instance to execute the application at a third performance level which is a performance level lower than the second performance level and to stream the screen corresponding to the application execution to the external device 200. Here, the first information may include an execution command for the at least one second processor and status information of the application. The at least one first processor may provide the first information to the at least one second processor and then terminate the running of the second instance. Furthermore, the at least one first processor has higher performance than the at least one second processor, so it is more expensive, and since the at least one second processor, instead of the at least one first processor, executes the application, costs may be saved.

Based on a third period of time, greater than the second period of time, having elapsed since the information corresponding to the user's absence was received, the at least one second processor may run a fourth instance to execute the application and terminate the streaming of the screen corresponding to the application execution. That is, the at least one second processor may execute the application but not perform an operation related to streaming the screen corresponding to the application execution. Costs may be saved because the at least one second processor does not stream the screen corresponding to the application execution.

Based on the information corresponding to the user's presence from the external device 200 via the communication interface 110, the at least one second processor may control the communication interface 110 to run the third instance to execute the application at the third performance level and stream the screen corresponding to the application execution to the external device 200 and provides the at least one first processor with second information for controlling the at least one first processor to execute the application, and the at least one first processor may control the communication interface 110 to run the first instance to execute the application at the first performance level and stream the screen corresponding to the application execution to the external device 200. That is, the electronic device 100 may stream the screen corresponding to the execution of the third-performance application to the external device 200, and thereafter, based on the completion of the running of the first instance by the at least one first processor, the electronic device 100 may stream the screen corresponding to the execution of the first-performance application to the external device 200. Once the screen corresponding to the execution of the first-performance application is streamed to the external device 200, the at least one second processor may terminate the running of the third instance.

In the above, although the first through fourth instances have been used as examples, the disclosure is not limited thereto, and instances may be run in various manners. For example, based on the first period of time having lapsed since the information corresponding to the user's absence was received while the at least one first processor is running the application with the first instance, the at least one second processor may execute the application with the fourth instance.

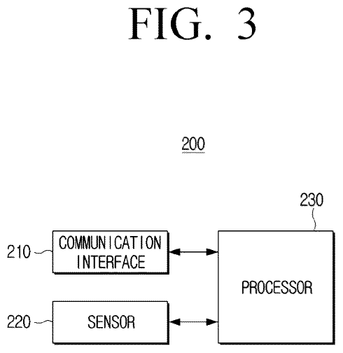

FIG. 3 is a block diagram illustrating a configuration of the external device 200 according to an embodiment of the disclosure.

The external device 200 may be a device that displays a screen corresponding to execution of an application received from the electronic device 100. For example, the external device 200 may be a device equipped with a display, such as a TV, desktop PC, laptop, digital video disk (DVD) player, smartphone, tablet personal computer (PC), monitor, smart glasses, or smartwatch, and may display a screen corresponding to the execution of the application received from the electronic device 100. Alternatively, the external device 200 may be a device without a display, such as a speaker or computer body. In this case, the external device 200 may transmit a screen corresponding to the execution of the application received from the electronic device 100 to a device equipped with a display. During this process, the external device 200 may decode the screen corresponding to the execution of the application received from the electronic device 100 and transmit the decoded screen to the device equipped with a display.

According to FIG. 3, the external device 200 includes a communication interface 210, a sensor 220, and one or more processors 230 one or more processors 230. In some embodiments, the external device 200 may include multiple sensors 220.

The communication interface 210 is a component that performs communication with various types of external devices according to various communication methods. For example, the external device 200 may communicate with the electronic device 100, a user terminal, etc., through the communication interface 210.

The communication interface 210 may include a Wi-Fi module, a Bluetooth module, an infrared communication module, and a wireless communication module. Each communication module may be implemented in the form of at least one hardware chip.

The Wi-Fi module and Bluetooth module perform communication via Wi-Fi and Bluetooth, respectively. In the case of using the Wi-Fi or Bluetooth module, various connection information, such as the SSID and session key, may be first transmitted and received, and this information may then be used to establish a communication connection to transmit and receive various information. The infrared communication module performs communication using IrDA technology to transmit data wirelessly over short distances by using infrared light which lies between visible light and millimeter waves,.

In addition to the aforementioned communication methods, the wireless communication module may include at least one communication chip performing communication according to various wireless communication standards, such as Zigbee, 3G, 3GPP, LTE, LTE-A, 4G, and 5G.

Alternatively, the communication interface 210 may include a wired communication interface, such as HDMI, DP, Thunderbolt, USB, RGB, D-SUB, or DVI.

In addition, the communication interface 210 may include at least one of a local area network (LAN) module, an Ethernet module, or a wired communication module that performs communication using pair cables, coaxial cables, or fiber optic cables.

The sensor 220 may be configured to detect the user's presence. For example, the sensor 220 may include at least one of a camera, a red, green, blue, and depth (RGB-D) sensor, or a time-of-flight (ToF) sensor.

The one or more processors 230 may capture still or moving images via the camera and identify the user's presence from the captured images. Alternatively, the one or more processors 230 may acquire RGB images in the visible light range, depth images via infrared (IR), and thermal images via IR through the RGB-D sensor, and identify the user's presence from these images. Alternatively, the one or more processors 230 may calculate a distance over which light emitted from an object to bounce back through the ToF sensor to recognize three-dimensionality, spatial information, and movement of an object, thereby identifying the user's presence.

However, without being limited thereto, the sensor 220 may be of any configuration that identifies the user's presence.

The one or more processors 230 controls the overall operation of the external device 200. Specifically, the one or more processors 230 may be connected to each component of the external device 200 and may control the overall operation of the electronic device 100. For example, the one or more processors 230 may be connected to components, such as the communication interface 210, the sensor 220, and memory to control the operation of the external device 200.

The one or more processors 230 may include one or more of a CPU, a GPU, an APU, a MIC, an NPU, a hardware accelerator, or a machine learning accelerator. The one or more processors 230 may control one or any combination of other components of the external device 200 and perform communication-related operations or data processing. The one or more processors 230 may execute one or more programs or instructions stored in memory. For example, the one or more processors 230 may execute one or more instructions stored in memory to perform the method according to an embodiment of the disclosure.

In case that the method according to an embodiment of the disclosure includes a plurality of operations, the plurality of operations may be performed by one processor or a plurality of processors. For example, when a first operation, a second operation, and a third operation are performed by a method according to an embodiment, the first, second, and third operations may all be performed by the first processor, or the first and second operations may be performed by the first processor (e.g., a general-purpose processor) and the third operation may be performed by the second processor (e.g., an AI-specific processor).

The one or more processors 230 may be implemented as a single-core processor including one core or as one or more multi-core processors including a plurality of cores (e.g., homogeneous multi-cores or heterogeneous multi-cores). When one or more processors 230 are implemented as multi-core processors, each of the plurality of cores included in the multi-core processor may include internal processor memory, such as cache memory or on-chip memory, and a common cache shared by the plurality of cores may be included in the multi-core processor. Furthermore, each of the plurality of cores (or some of the plurality of cores) included in the multi-core processor may independently read and execute program instructions for implementing the method according to an embodiment of the disclosure, or all (or some) of the plurality of cores may be linked to read and execute program instructions for implementing the method according to an embodiment of the disclosure.

When the method according to an embodiment of the disclosure includes a plurality of operations, the plurality of operations may be performed by one of the plurality of cores included in the multi-core processor or by the plurality of cores. For example, when the first, second, and third operations are performed by the method according to an embodiment, the first, second, and third operations may all be performed by a first core included in the multi-core processor, or the first and second operations may be performed by a first core included in the multi-core processor, and the third operation may be performed by a second core included in the multi-core processor.

In embodiments of the disclosure, the one or more processors 230 may refer to a system-on-chip (SoC) in which one or more processors and other electronic components are integrated, a single-core processor, a multi-core processor, or a core included in the single-core processor or the multi-core processor. Here, the core may be implemented as a CPU, GPU, APU, MIC, NPU, hardware accelerator, or machine learning accelerator, but embodiments of the disclosure are not limited thereto. However, for convenience of description, the operation of the external device 200 will be described hereinafter by the expression of the one or more processors 230.

The one or more processors 230 may receive a screen corresponding to the execution of an application streamed from the electronic device 100 via the communication interface 210 and provide the screen corresponding to the execution of the application to the user. For example, the external device 200 may include a display, and the one or more processors 230 may control the display to provide the screen corresponding to the execution of the application to the user. Alternatively, the one or more processors 230 may provide the screen corresponding to the execution of the application to a device equipped with a display.

While providing the screen corresponding to the execution of the application to the user, the one or more processors 230 may detect the user's presence via the sensor 220, and based on the user identified as being absent, the one or more processors 230 may control the communication interface 210 to transmit information corresponding to the user's absence to the electronic device 100. Thereafter, based on the user identified as being present, the one or more processors 230 may control the communication interface 210 to transmit information corresponding to the user's presence to the electronic device 100.

The one or more processors 230 of the external device 200 may provide a timer function and control the communication interface 210 to receive information on the user's waiting time, which indicates the user's absence, from the user and transmit the received information to the electronic device 100.

As described above, the external device 200 may provide the user with a screen corresponding to the execution of the application received from the electronic device 100 and provide the electronic device 100 with information on the user's presence.

However, the disclosure is not limited thereto, and the external device 200 may also be a device authorized to control the electronic device 100. Hereinafter, a case in which the external device 200 is authorized to control the electronic device 100 is described.

Based on an execution command of an application received from the user, the one or more processors 230 may control the communication interface 210 to transmit the execution command of the application to the electronic device 100. In this case, the electronic device 100 may run the first instance to execute the application at the first performance level and stream the screen corresponding to the execution of the application to the external device 200, and the one or more processors 230 may display the screen corresponding to the execution of the application.

Based on the absence of the user detected through the sensor 220, the one or more processors 230 may control the communication interface 210 to transmit a control command for controlling the electronic device 100 to run the second instance and execute the application at the second performance level which is a performance level lower than the first performance level to the electronic device 100. Alternatively, based on the first period of time having elapsed since the absence of the user was detected through the sensor 220, the one or more processors 230 may control the communication interface 210 to transmit a control command for controlling the electronic device 100 to run the second instance and execute the application at the second performance level which is a performance level lower than the first performance level to the electronic device 100.

Thereafter, based on the user's presence detected through the sensor 220, the one or more processors 230 may control the communication interface 210 to transmit a control command for controlling the electronic device 100 to run the first instance and execute the application at the first performance level to the electronic device 100.

The one or more processors 230 may provide the user with a screen including a timer function and receive information on the waiting time of the application from the user. The one or more processors 230 may control the communication interface 210 to transmit a control command for controlling the electronic device 100 to run the second instance and execute the application at the second performance level to the electronic device 100 during the waiting time of the application.

The one or more processors 120 of the electronic device 100 may include a at least one first processor and at least one second processor with lower performance than the at least one first processor, and the one or more processors 230 of the external device 200 may control at least one of the at least one first processor or the at least one second processor.

For example, upon receiving an execution command of the application from the user, the one or more processors 230 may control the communication interface 210 to transmit a control command for controlling the at least one first processor to run the first instance and execute the application at the first performance level to the electronic device 100.

Based on the first period of time having elapsed since the sensor 220 detected the absence of the user, the one or more processors 230 may control the communication interface 210 to transmit a control command for controlling the electronic device 100 to run the second instance and execute the application at the second performance level which is a performance level lower than the first performance level to the electronic device 100. Based on that the first instance is changed to the second instance, at least one of a transmission bit rate of the screen corresponding to the execution of the application or the resolution of the application may be reduced and costs may be reduced.

Based on the second period of time, greater than the first period of time, having elapsed since the sensor 220 detected the absence of the user, the one or more processors 230 may control the communication interface 210 to transmit a control command for controlling the at least one second processor to run the third instance and execute the application at the third performance level which is a performance level lower than the second performance level to the electronic device 100. In this case, the at least one first processor may provide status information of the application to the at least one second processor and terminate the running of the second instance. The at least one first processor has higher performance than the at least one second processor and thus is more expensive. Therefore, since the at least one second processor, instead of the at least one first processor, runs the application, the costs may be reduced.

Based on the third period of time, greater than the second period of time, having elapsed since the sensor 220 detected the absence of the user, the one or more processors 230 may control the communication interface 210 to transmit a control command for controlling to run the fourth instance to execute the application and terminate streaming to the electronic device 100. Since the at least one second processor does not stream the screen corresponding to the execution of the application, costs may be reduced.

Based on the direction of the user's presence through the sensor 220, the one or more processors 230 may control the communication interface 210 to transmit a control command for controlling to run the third instance to execute the application at the third performance level and a control command for controlling the at least one first processor to run the first instance and execute the application at the first performance level to the electronic device 100. In this case, the electronic device 100 may stream a screen corresponding to the execution of the third-performance application to the external device 200, and thereafter, based on the completion of the running of the first instance by the at least one first processor, the electronic device 100 may stream the screen corresponding to the execution of the first performance application to the external device 200. Once the screen corresponding to the execution of the first-performance application is streamed to the external device 200, the at least one second processor may terminate the running of the third instance.

In the above, although the first through fourth instances have been used as examples, the disclosure is not limited thereto, and the instances may be run in various manners. For example, based on the first period of time having lapsed since the user's absence was detected by the sensor 220, while the at least one first processor is executing the application with the first instance, the one or more processors 230 may control the communication interface 210 to transmit a control command for controlling the at least one second processor to execute the application with the fourth instance to the electronic device 100.

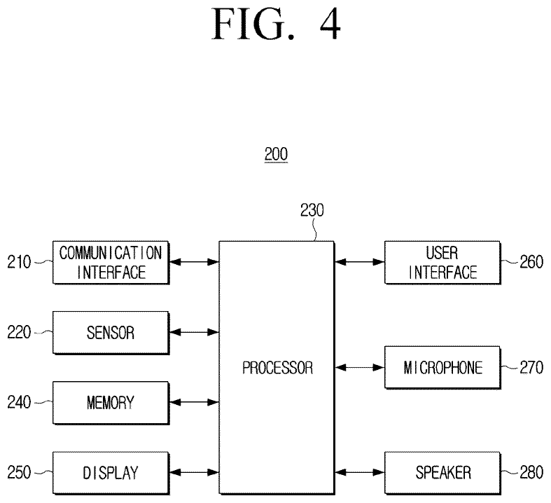

FIG. 4 is a block diagram illustrating a detailed configuration of the external device 200 according to an embodiment of the disclosure. The external device 200 may include the communication interface 210, the sensor 220, and the one or more processors 230. Furthermore, according to FIG. 4, the electronic device 100 may further include a memory 240, a display 250, a user interface 260, a microphone 270, and a speaker 280.

The memory 240 may refer to hardware that stores information, such as data, in an electrical or magnetic form so that the one or more processors 230 or the like may access the information. To this end, the memory 240 may be implemented as at least one of non-volatile memory, volatile memory, flash memory, a hard disk drive (HDD), a solid-state drive (SSD), random-access memory (RAM), read-only memory (ROM), or the like.

The memory 240 may store at least one instruction required for the operation of the external device 200 or the one or more processors 230. Here, an instruction is a code unit that indicates the operation of the external device 200 or the one or more processors 230 and may be written in machine language, a language understandable by a computer. Alternatively, the memory 240 may store a plurality of instructions for performing specific tasks of the external device 200 or one or more processors 230 as an instruction set.

The memory 240 may store data, which is information in bit or byte unit that may represent characters, numbers, images, etc. For example, the memory 240 may store a user detection module, a timer module, etc.

The memory 240 is accessed by the one or more processors 230, and instructions, instruction sets, or data may be read/written/modified/deleted/updated by the one or more processors 230.

The display 250 displays images and may be implemented in various forms, such as an LCD (Liquid Crystal Display), an OLED (Organic Light Emitting Diodes) display, or a PDP (Plasma Display Panel). The display 250 may also include a driving circuit, a backlight unit, or the like, which may be implemented in forms, such as an a-si TFT (thin-film-transistor), a LTPS (low temperature poly silicon) TFT, or an OTFT (organic TFT). Meanwhile, the display 250 may be implemented as a touch screen combined with a touch sensor, a flexible display, a 3D display, or the like.

The one or more processors 230 may control the display 250 to display a screen corresponding to the execution of an application received from the electronic device 100.

The user interface 260 may be implemented as a button, a touchpad, a mouse, a keyboard, or a touchscreen capable of performing both display and operation input functions. Here, the button may be various types of buttons, such as a mechanical button, a touchpad, or a wheel, formed in a certain region of the external device 200, such as a front surface portion, a side surface portion, or a rear surface portion of the exterior of a main body.

The microphone 270 is a component that receives sound and converts the sound into an audio signal. The microphone 270 may be electrically connected to the one or more processors 230 and may receive sound under the control of the one or more processors 230.

For example, the microphone 270 may be formed as an integrated unit integrated on the top, front, or side of the external device 200. Alternatively, the microphone 270 may be installed in a remote controller, separate from the external device 200. In this case, the remote controller may receive sound through the microphone 270 and provide the received sound to the external device 200.

The microphone 270 may include various components, such as a microphone that collects analog sound, an amplifier circuit that amplifies the collected sound, an A/D conversion circuit that samples the amplified sound and converts the same into a digital signal, and a filter circuit that cancels noise from the converted digital signal.

The microphone 270 may be implemented in the form of a sound sensor, or any other component capable of collecting sound may be used.

The one or more processors 230 may also identify the user's presence through the microphone 270.

The speaker 280 is a component that outputs various audio data processed by the one or more processors 230, as well as various notification sounds and voice messages.

As described above, the electronic device 100 may reduce costs by changing the operating performance of an application based on the user's presence or absence of the external device 200.

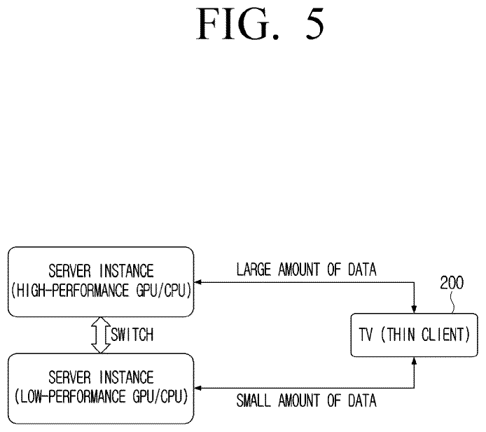

Hereinafter, the operation of the electronic device 100 is described in more detail with reference to FIGS. 5 through 10. For convenience of description, individual embodiments are described with reference to FIGS. 5 to 10. However, the individual embodiments of FIGS. 5 through 10 may be implemented in any combination.

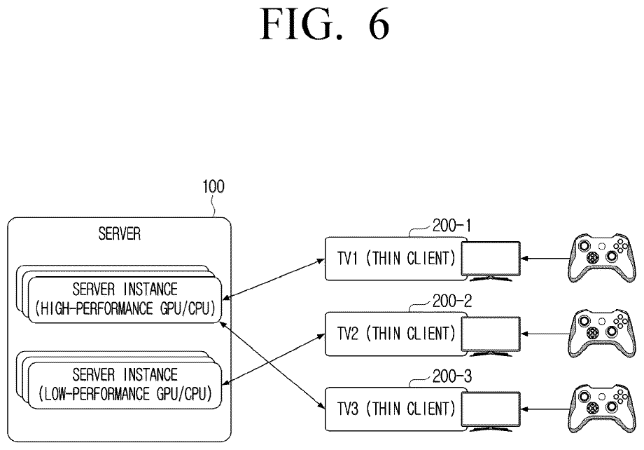

FIGS. 5 and 6 are diagrams illustrating costs for each performance according to an embodiment of the disclosure.

Based on information corresponding to the user's absence received from the external device 200, the one or more processors 120 may change the first instance to the second instance and execute the application at the second performance level which is a performance level lower than the first performance level.

For example, as illustrated in FIG. 5, based on the user's presence or absence, the one or more processors 120 may use the first instance of a high-performance GPU/CPU or the second instance of a low-performance GPU/CPU. Based on the application executed with the first instance of the high-performance GPU/CPU, the amount of data is relatively large, and based on the application executed with the second instance of the low-performance GPU/CPU, the amount of data is relatively small. When the user is absent, the application may be executed with the second instance of the low-performance GPU/CPU, thereby reducing costs.

The electronic device 100 may run a plurality of instances, respectively corresponding to a plurality of external devices 200-1, 200-2, and 200-3. For example, as illustrated in FIG. 6, the one or more processors 120 may execute the application with the first instance of the high-performance GPU/CPU for the first external device 200-1 and the third external device 200-3 in which the user is present and may execute the application with the second instance of the low-performance GPU/CPU for the second external device 200-2 in which the user is absent.

Through the above operations, the execution status of the application may be maintained even when the user is absent. In addition, when the user is absent, costs may be reduced by using a low-performance instance.

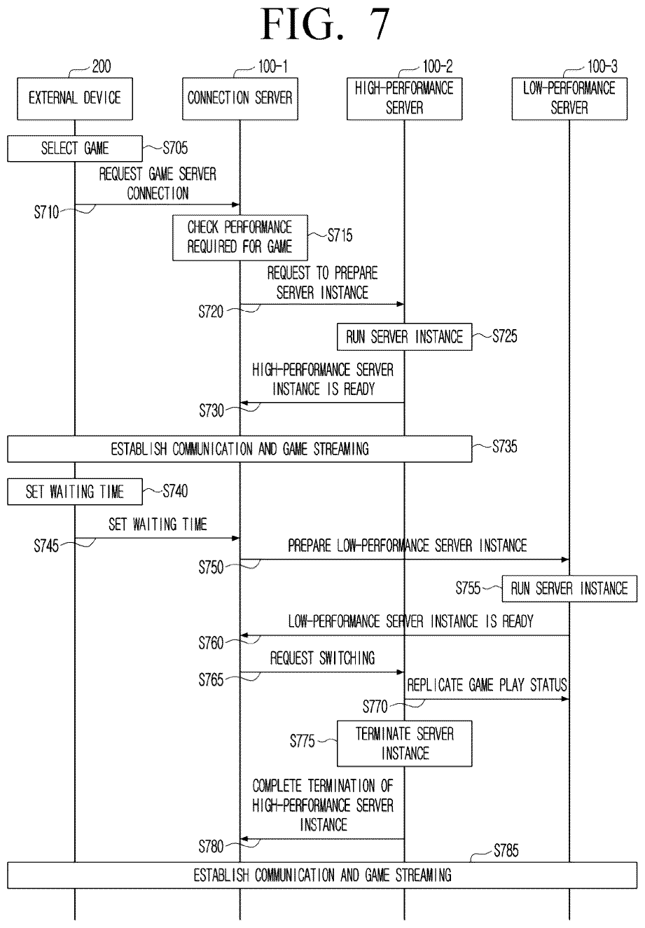

FIG. 7 is a sequence diagram illustrating an operation according to a waiting time setting according to an embodiment of the disclosure. For convenience of description, in FIG. 7, the electronic device 100 is illustrated as including a connection server 100-1, a high-performance server 100-2, and a low-performance server 100-3. Furthermore, the application is described as a game.

First, based on a user command to select a game being received (S705), the external device 200 may request a game server connection to the connection server 100-1 (S710).

The connection server 100-1 may check the performance required for the game (S715) and request the high-performance server 100-2 to prepare a server instance (S720).

The high-performance server 100-2 may run a server instance (S725) and transmit to the connection server 100-1 a notification that the high-performance server instance is ready (S730).

The connection server 100-1 may establish communication between the external device 200 and the high-performance server 100-2 and perform game streaming (S735).

Thereafter, based on a user command for setting a waiting time being received (S740), the external device 200 may transmit a control command requesting the waiting time setting to the connection server 100-1 (S745).

The connection server 100-1 may request the low-performance server 100-3 to prepare a low-performance server instance (S750).

The low-performance server 100-3 may run a server instance (S755) and transmit to the connection server 100-1 a notification that the low-performance server instance is ready (S760).

The connection server 100-1 may request switching from the high-performance server 100-2 (S765), and the high-performance server 100-2 may transmit a game play status to the low-performance server 100-3 (S770). That is, the low-performance server 100-3 may replicate the current game play status of the high-performance server 100-2. After transmitting the game play status, the high-performance server 100-2 terminates the server instance (S775) and transmits to the connection server 100-1 a notification that the termination of the high-performance server instance has been completed (S780).

The connection server 100-1 may establish communication between the external device 200 and the low-performance server 100-3 and performs game streaming (S785).

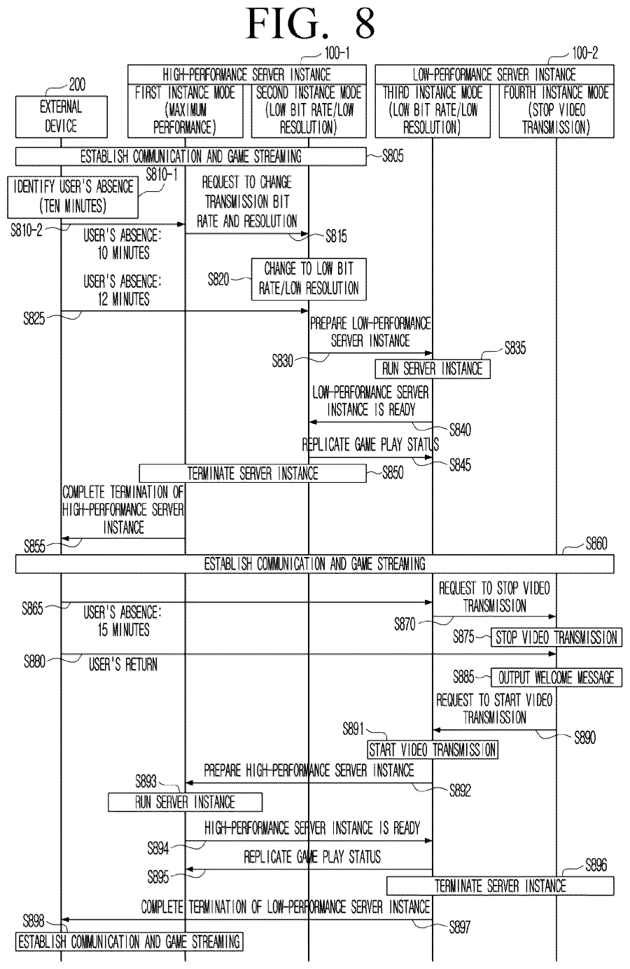

FIG. 8 is a sequence diagram illustrating an instance change operation according to an embodiment of the disclosure. For convenience of description, in FIG. 8, the electronic device 100 is illustrated as operating as a high-performance server instance 100-1 or a low-performance server instance 100-2. Here, the high-performance server instance 100-1 may include a relatively high-performance GPU/CPU, as compared to the low-performance server instance 100-2. The high-performance server instance 100-1 may operate in a first instance mode with maximum performance or a second instance mode with low bit rate/low resolution. The low-performance server instance 100-2 may run in a third instance mode or a fourth instance mode in which a video is not transmitted, and the third instance mode may have a lower bit rate and resolution than the second instance mode. In FIG. 8, each mode is illustrated as being capable of transmitting and receiving data, but this is to highlight the current mode of each server instance, and in reality, it may be the operation of each server instance. Meanwhile, the application is described as being a game.

First, the high-performance server instance 100-1 may establish communication with the external device 200 and may perform game streaming (S805).

Thereafter, based on the user's absence identified for, for example, 10 minutes (S810-1), the external device 200 may provide information corresponding to the user's absence to the first instance mode of the high-performance server instance 100-1 (S810-2).

The first instance mode may request a change in transmission bit rate and resolution to the second instance mode (S815), and the second instance mode may change an operating status to a low bit rate and low resolution (S820).

Thereafter, based on the user's absence identified for, for example, 12 minutes, the external device 200 may provide information corresponding to the user's absence to the second instance mode of the high-performance server instance 100-1 (S825).

The second instance mode may request the low-performance server instance 100-2 to prepare a low-performance server instance from the third instance mode (S830).

The third instance mode may operate the server instance (S835) and transmit to the second instance mode that the low-performance server instance is ready (S840).

The second instance mode may provide a game play status to the third instance mode (S845), and the high-performance server instance 100-1 may terminate the server instance (S850) and transmit to the external device 200 a notification that the termination of the high-performance server instance is completed (S855).

The low-performance server instance 100-2 may establish communication with the external device 200 and perform game streaming (S860).

Thereafter, based on the user's absence identified for, for example, 15 minutes, the external device 200 may provide information corresponding to the user's absence to the third instance mode (S865). The third instance mode may request the fourth instance mode to stop video transmission (S875), and the fourth instance mode may stop video transmission (S875).

Based on the user's return being identified, the external device 200 may transmit information on the user's return to the fourth instance mode (S880), and the fourth instance mode may output a welcome message (S885) and request the third instance mode to start video transmission (S890).

The third instance mode may start video transmission (S891) and request the first instance mode to prepare a high-performance server instance (S892).

The first instance mode may run the server instance (S893) and transmit to the third instance mode a notification that the high-performance server instance is ready (S894).

The third instance mode may provide the game play status to the second instance mode (S895), and the low-performance server instance 100-2 may terminate the server instance (S896) and transmit to the external device 200 a notification that the termination of the low-performance server instance has been completed (S897).

The first instance mode may establish communication with the external device 200 and perform game streaming (S898).

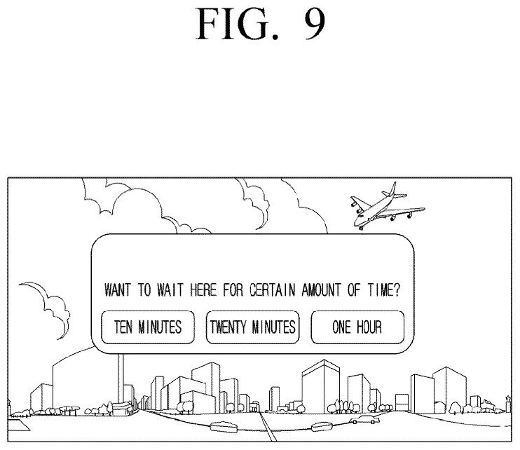

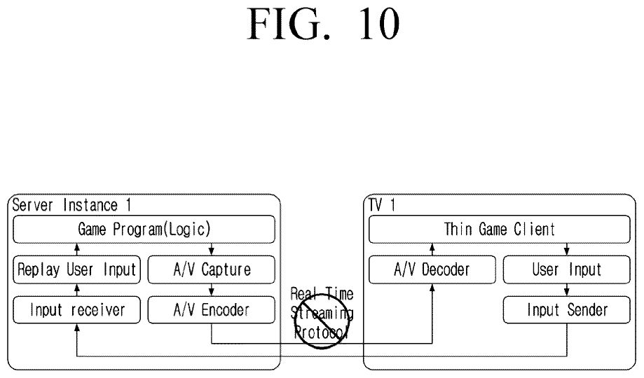

FIGS. 9 and 10 are diagrams illustrating a timer function according to an embodiment of the disclosure.

The one or more processors 230 of the external device 200 may provide a timer function. For example, based on a user's timer function execution command or the user's absence identified for a predetermined period of time, the one or more processors 230 may display a UI representing the timer function, as illustrated in FIG. 9.

Based on a command for a waiting time received from the user, the one or more processors 230 may transmit information on the waiting time to the electronic device 100, and the electronic device 100 may change the instance to a low-performance during the waiting time.

For example, as illustrated in FIG. 10, the electronic device 100 may not transmit the screen during the waiting time.

However, without being limited thereto, the electronic device 100 may also lower the transmission frame rate of the screen or the resolution of the screen during the waiting time.

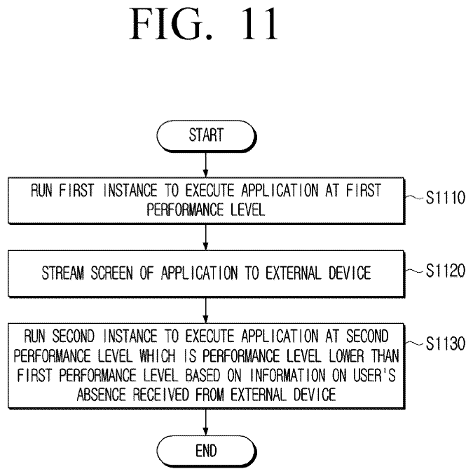

FIG. 11 is a flowchart illustrating a control method of an electronic device according to an embodiment of the disclosure.

First, a first instance is run to execute an application at a first performance level (S1110). Also, a screen corresponding to the execution of the application is streamed to an external device (S1120). Then, based on information corresponding to the user's absence received from the external device, a second instance is run to execute the application at a second performance level which is a performance level lower than the first performance level (S1130).

In addition, in the operation of executing the application at the second performance level (S1130), based on a first period of time having elapsed since the information corresponding to the user's absence was received, the application may be executed at the second performance level by running the second instance.

Also, in the operation of executing the application at the first performance level (S1110), the at least one first processor may run the first instance to execute the application at the first performance level, and in the operation of executing the application at the second performance level (S1130), based on the first period of time having elapsed since the information corresponding to the user's absence was received, the at least one second processor may run the second instance with lower performance than the at least one first processor to lower at least one of the transmission bit rate of the screen corresponding to the execution of the application or the resolution of the application.

Furthermore, an operation in which, based on the second period of time, greater than the first period of time, having elapsed since the information corresponding to the user's absence was received, the at least one first processor transmits first information for controlling the at least one second processor to execute the application to the at least one second processor and an operation in which the at least one second processor runs the third instance to execute the application at a third performance level which is a performance level lower than the second performance level may be further included.

Furthermore, an operation in which, based on a third period of time, greater than the second period of time period, having elapsed since the information corresponding to the user's absence was received, the at least one second processor runs a fourth instance to execute the application and an operation of terminating the streaming of the screen corresponding to the execution of the application may be further included.

Furthermore, an operation in which, based on information corresponding to the user's presence received from an external device, the at least one second processor runs the third instance to execute the application at the third performance level, an operation in which the at least one second processor provides second information for controlling the at least one first processor to execute the application to the at least one first processor, and an operation in which the at least one first processor runs the first instance to execute the application at the first performance level may be further included.

Furthermore, the first information may include an execution command for the at least one second processor and status information of the application, and an operation in which the at least one first processor provides the first information to the at least one second processor and then the running of the second instance is terminated may be further included.

Furthermore, an operation of, based on information corresponding to the user's presence received from an external device, running the first instance to execute the application at the first performance level may be further included.

Furthermore, an operation of, based on information regarding a waiting time of the application received from an external device, running the second instance during the waiting time and executing the application at the second performance level may be further included.

Furthermore, in the operation of executing the application at the first performance level (S1110), based on an execution command of the application received from the external device, the application may be executed at the first performance level by running the first instance.

According to various embodiments of the disclosure, the electronic device may reduce costs by changing the operating performance of the application based on the presence of the user of the external device.

According to an embodiment of the disclosure, the various embodiments described above may be implemented in software including an instruction stored in a machine-readable storage medium (for example, a computer-readable storage medium). A machine may be a device that invokes the stored instruction from a storage medium, may be operated based on the invoked instruction, and may include the electronic apparatus according to the disclosed embodiments. Based on the instruction being executed by the processor, the processor may directly perform a function corresponding to the instruction, or other components may perform the function corresponding to the instruction under a control of the processor. The instruction may include codes generated or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored in the storage medium.

Also, according to an embodiment of the disclosure, the method according to the aforementioned various embodiments may be provided while being included in a computer program product. A computer program product refers to a product, and it may be traded between a seller and a buyer. A computer program product may be distributed in the form of a storage medium that is readable by machines (e.g.: a compact disc read only memory (CD-ROM)), or may be distributed on-line through an application store (e.g.: Play Store™). In the case of on-line distribution, at least a portion of a computer program product may be stored in a storage medium, such as the server of the manufacturer, the server of the application store, and the memory of the relay server at least temporarily, or may be generated temporarily.

Also, according to an embodiment of the disclosure, the aforementioned various embodiments may be implemented in a recording medium that may be read by a computer or an apparatus similar to a computer, by using software, hardware, or a combination thereof. In some cases, the embodiments described in this specification may be implemented as a processor itself. According to implementation by software, the embodiments, such as processes and functions described in this specification may be implemented as separate software modules. Each of the software modules may perform one or more functions and operations described in this specification.

Computer instructions for performing processing operations of machines according to the aforementioned various embodiments may be stored in a non-transitory computer-readable medium. Computer instructions stored in such a non-transitory computer-readable medium make the processing operations at machines according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment, such as a register, a cache, and a memory. As specific examples of a non-transitory computer-readable medium, there may be a CD, a DVD, a hard disc, a blue-ray disc, a USB, a memory card, a ROM and the like.

Also, each of the components according to the aforementioned various embodiments (e.g.: a module or a program) may consist of a singular object or a plurality of objects. Also, among the aforementioned corresponding sub components, some sub components may be omitted, or other sub components may be further included in the various embodiments. Alternatively or in addition, some components (e.g.: a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

Example embodiments of the disclosure have been shown and described, but the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic device comprising:
a communication interface; and
one or more processors operatively connected to the communication interface,
wherein the one or more processors are configured to:
execute an application at a first performance level by running a first instance,
control the communication interface to stream a screen corresponding to the execution of the application to an external device, and
execute, based on information corresponding to a user absence received from the external device through the communication interface, the application at a second performance level by running a second instance, wherein the second performance level is lower than the first performance level.

2. The electronic device as clamed in claim 1, wherein the one or more processors are further configured to, based on a first period of time having elapsed since the information corresponding to the user absence was received, execute the application at the second performance level by running the second instance.

3. The electronic device as clamed in claim 2, wherein the one or more processors comprise:
at least one first processor; and
at least one second processor having a lower performance than the at least one first processor,
wherein the at least one first processor is configured to:
execute the application at the first performance level by running the first instance,
control the communication interface to stream the screen corresponding to the execution of the application to the external device, and
based on the first period of time having elapsed since the information corresponding to the user absence was received, lower at least one of a transmission bit rate of the screen corresponding to the execution of the application or a resolution of the application by running the second instance.

4. The electronic device as clamed in claim 3, wherein the at least one first processor is further configured to, based on a second period of time having elapsed since the information corresponding to the user absence was received, provide first information for controlling the at least one second processor to execute the application to the at least one second processor, the second period of time being greater than the first period of time, and
wherein the at least one second processor is further configured to execute the application at a third performance level by running a third instance and control the communication interface to stream the screen corresponding to the execution of the application to the external device, the third performance level being lower than the second performance level.

5. The electronic device as clamed in claim 4, wherein the at least one second processor is further configured to, based on a third period of time having elapsed since the information corresponding to the user absence was received, execute the application by running a fourth instance and terminate the streaming of the screen corresponding to the execution of the application, the third period of time being greater than the second period of time.

6. The electronic device as clamed in claim 5, wherein the at least one second processor is further configured to:
execute, based on information corresponding to a user presence received from the external device through the communication interface, the application at the third performance level by running the third instance and control the communication interface to stream the screen corresponding to the execution of the application to the external device, and
provide second information for controlling the at least one first processor to execute the application to the at least one first processor, and
wherein the at least one first processor is further configured to execute the application at the first performance level by running the first instance and control the communication interface to stream the screen corresponding to the execution of the application to the external device.

7. The electronic device as clamed in claim 4, wherein the first information comprises an execution command of the at least one second processor and status information of the application, and
wherein the at least one first processor is further configured to terminate the running of the second instance after providing the first information to the at least one second processor.

8. The electronic device as clamed in claim 1, wherein the one or more processors are further configured to execute, based on information corresponding to a user presence received from the external device through the communication interface, the application at the first performance level by running the first instance.

9. The electronic device as clamed in claim 1, wherein the one or more processors are further configured to execute, based on information on a waiting time of the application received from the external device, the application at the second performance level by running the second instance during the waiting time.

10. The electronic device as clamed in claim 1, wherein the one or more processors are configured to execute, based on an execution command of the application received from the external device, the application at the first performance level by running the first instance.

11. A control method of an electronic device, the control method comprising:
executing an application at a first performance level by running a first instance;
streaming a screen corresponding to the execution of the application to an external device; and
executing, based on information corresponding to a user absence received from the external device, the application at a second performance level by running a second instance, wherein the second performance level is lower than the first performance level.

12. The control method as claimed in claim 11, wherein the executing the application at the second performance level comprises, based on a first period of time having elapsed since the information corresponding to the user absence was received, executing the application at the second performance level by running the second instance.

13. The control method as claimed in claim 12, wherein the executing the application at the first performance level comprises executing the application at the first performance level by running, by at least one first processor, the first instance,
wherein the executing the application at the second performance level comprises, based on the first period of time having elapsed since the information corresponding to the user absence was received, lowering at least one of a transmission bit rate of the screen corresponding to the execution of the application or a resolution of the application by running, by at least one second processor, the second instance, and
wherein the at least one second processor has a lower performance than the at least one first processor.

14. The control method as claimed in claim 13, further comprising:
based on a second period of time having elapsed since the information corresponding to the user absence was received, providing, by the at least one first processor, first information for controlling the at least one second processor to execute the application to the at least one second processor, the second period of time being greater than the first period of time; and
executing, by the at least one second processor, the application at a third performance level by running a third instance, the third performance level being lower than the second performance level.

15. The control method as claimed in claim 14, further comprising:
based on a third period of time having elapsed since the information corresponding to the user absence was received, executing the application by running a fourth instance by the at least one second processor, the third period of time being greater than the second period of time; and
terminating the streaming of the screen corresponding to the execution of the application.
